(19) United States
(12) Patent Application Publication
(10) Pub. No.: US 2026/0039872 A1
(43) Pub. Date: Feb. 5, 2026

(54) VISUAL VOLUMETRIC VIDEO-BASED ENCODING METHOD AND DECODING METHOD, ENCODER AND DECODER

(71) Applicant: GUANGDONG OPPO MOBILE TELECOMMUNICATIONS CORP., LTD., Dongguan (CN)

(72) Inventors: Yue YU, Dongguan (CN); Vladyslav ZAKHARCHENKO, Dongguan (CN); Haoping YU, Dongguan (CN)

(21) Appl. No.: 19/353,305

(22) Filed: Oct. 8, 2025

Related U.S. Application Data
(63) Continuation of application No. PCT/CN2024/087062, filed on Apr. 10, 2024.
(60) Provisional application No. 63/458,642, filed on Apr. 11, 2023.

(51) Int. Cl. H04N 19/597; H04N 19/46; H04N 19/70

(52) U.S. Cl. CPC H04N 19/597; H04N 19/46; H04N 19/70

(57) ABSTRACT

A visual volumetric video-based coding (V3C) method, applied to a decoder and includes: decoding, from a bitstream of a volumetric video, a first flag indicating whether a plurality of duplicated points are reconstructed for a current atlas, where each of the plurality of duplicated points is a point with same geometry coordinates as another point from an associated lower indexed map with a same patch; setting a first default value to the first flag to indicate that the plurality of duplicated points are not reconstructed in response to the first flag being not present; and decoding a volumetric content from the bitstream to reconstruct the volumetric video according to a value of the first flag.

### CROSS-REFERENCE TO RELATED APPLICATION

This application is a Continuation application of International Application No. PCT/CN2024/087062 filed Apr. 10, 2024, which claims the priority benefit of U.S. provisional application Ser. No. 63/458,642, filed on Apr. 11, 2023. The entireties of the above-mentioned patent applications are hereby incorporated by reference herein and made a part of this specification.

### TECHNICAL FIELD

The disclosure relates generally to computer-implemented methods and systems for video processing. Specifically, the disclosure relates to Visual Volumetric Video-based Coding (V3C).

### BACKGROUND

Video-based Point Cloud Coding (V-PCC) is widely used in VR/AR for entertainment and industrial applications. MPEG released the first version V-PCC standard. In order to compress the point cloud data efficiently, the 3-D point cloud is projected to 2-D images. There are three kinds of images plus one meta data after projection. Geometry image is used to represent the geometry information of PCC. Attribute image is used to represent the texture information. Occupancy image is used to represent the occupied area of PCC. Meta data is used to indicate the information regarding patch, e.g. position, size etc. All three images may be coded with existing video codecs.

A MPEG Immersive video (MIV) may include multiple view port video. In order to efficiently compress such immersive video, one or more basic view port video is selected. For remaining other view port video, the redundancy between remaining view port video and basic video are removed first and only non-overlapped parts are kept. The basic view port and non-overlapped view port video are re-patched together to form a bigger size patched video. The patched video and corresponding information are coded by existing video codecs and other coding method, respectively.

Unlike traditional video, volumetric video is comprised of a sequence of frames, where each frame is a 3D representation of a real-world object or scene capture from a moment in time. The MPEG Visual Volumetric Video-based Coding (V3C) standard defines the general mechanism for coding and streaming volumetric content. The first two main codecs associated with MPEG V3C standard are V-PCC for point clouds data transmission and MPEG Immersive Video (MIV) for multi-views with depth content.

However, the existing V3C cannot work well for a wide range of point cloud and also bring extra complexity. It is desirable to design a general V3C system and method that can be used in many applications.

### SUMMARY

The embodiments of the present disclosure provide a visual volumetric video-based coding (V3C) method, an encoder, and a decoder.

In a first aspect, an embodiment of the present disclosure provides a visual volumetric video-based coding (V3C) method, applied to a decoder. The method comprises decoding, from a bitstream of a volumetric video, a first flag indicating whether a plurality of duplicated points are reconstructed for a current atlas, where each of the plurality of duplicated points is a point with same geometry coordinates as another point from an associated lower indexed map with a same patch; setting a first default value to the first flag to indicate that the plurality of duplicated points are not reconstructed in response to the first flag being not present; and decoding a volumetric content from the bitstream to reconstruct the volumetric video according to a value of the first flag.

According to one embodiment, the method further comprises decoding, from the bitstream, a second syntax element specifying a maximum absolute difference between an explicitly coded depth value and an interpolated depth value minus one; setting a second default value to the second syntax element to set the maximum absolute difference to be equal to the second default value plus one in response to the second syntax element being not present; and decoding the volumetric content from the bitstream to reconstruct the volumetric video according to the values of the first flag and the second syntax element.

According to one embodiment, the method further comprises decoding, from the bitstream, a third flag indicating whether there is extension data associated with at least one specific format of volumetric content in the bitstream; and decoding, from the bitstream, a fourth flag indicating whether there are point cloud extension syntax elements, where the fourth flag is enabled in response to the third flag being enabled; decoding the point cloud extension syntax elements from the bitstream according to the value of the fourth flag; and decoding the volumetric content from the bitstream using the point cloud extension syntax elements to reconstruct the volumetric video.

According to one embodiment, the method further comprises decoding, from the bitstream, a fifth flag indicating whether there are multi-view video extension syntax elements for a video-based point cloud compression (V-PCC) profile; and decoding, from the bitstream, the point cloud extension syntax elements without the multi-view video extension syntax elements for the V-PCC profile in response to the fifth flag being disabled.

According to one embodiment, the method further comprises decoding, from the bitstream, a sixth flag specifying whether a fifth flag is present, where the fifth flag indicates whether there are multi-view video extension syntax elements for a V-PCC profile; and decoding, from the bitstream, the point cloud extension syntax elements without the multi-view video extension syntax elements for the V-PCC profile in response to the sixth flag being disabled.

In a second aspect, an embodiment of the present disclosure provides a decoder. The decoder comprises a communication interface, a storage device, and a processor. The communication interface is configured to retrieve a bitstream of a volumetric video. The storage device is configured to store the bitstream of the volumetric video. The processor is coupled to the communication interface and the storage device, and configured to decode, from a bitstream of a volumetric video, a first flag indicating whether a plurality of duplicated points are reconstructed for a current atlas, where each of the plurality of duplicated points is a point with same geometry coordinates as another point from an associated lower indexed map with a same patch, set a first default value to the first flag to indicate that the plurality of duplicated points are not reconstructed in response to the first flag being not present, and decode a volumetric content of the volumetric video from the bitstream to reconstruct the volumetric video according to a value of the first flag.

According to one embodiment, the processor is further configured to decode, from the bitstream, a second syntax element specifying a maximum absolute difference between an explicitly coded depth value and an interpolated depth value minus one, set a second default value to the second syntax element to set the maximum absolute difference to be equal to the second default value plus one in response to the second syntax element being not present, and decode the volumetric content from the bitstream to reconstruct the volumetric video according to the values of the first flag and the second syntax element.

According to one embodiment, the processor is further configured to decode, from the bitstream, a third flag indicating whether there is extension data associated with at least one specific format of volumetric content in the bitstream, and decode, from the bitstream, a fourth flag indicating whether there are point cloud extension syntax elements, where the fourth flag is enabled in response to the third flag being enabled, decode the point cloud extension syntax elements from the bitstream according to the value of the fourth flag, and decode the volumetric content from the bitstream using the point cloud extension syntax elements to reconstruct the volumetric video.

According to one embodiment, the processor is further configured to decode, from the bitstream, a fifth flag indicating whether there are multi-view video extension syntax elements for a video-based point cloud compression (V-PCC) profile, and decode, from the bitstream, the point cloud extension syntax elements without the multi-view video extension syntax elements for the V-PCC profile in response to the fifth flag being disabled.

According to one embodiment, the processor is further configured to decode, from the bitstream, a sixth flag specifying whether a fifth flag is present, where the fifth flag indicates whether there are multi-view video extension syntax elements for a V-PCC profile, and decode, from the bitstream, the point cloud extension syntax elements without the multi-view video extension syntax elements for the V-PCC profile in response to the sixth flag being disabled.

In a third aspect, an embodiment of the present disclosure provides a visual volumetric video-based coding (V3C) method, applied to an encoder. The method comprises processing data of a volumetric video to determine whether a plurality of duplicated points are reconstructed for a current atlas, where each of the plurality of duplicated points is a point with same geometry coordinates as another point from an associated lower indexed map with a same patch; encoding a first flag indicating whether the plurality of duplicated points are reconstructed for the current atlas into a bitstream of the volumetric video according to a result of the processing; and encoding a second flag indicating whether there are point cloud extension syntax elements into the bitstream, where the first flag is not encoded in response to the second flag being disabled.

According to one embodiment, the method further comprises encoding a third syntax element specifying a maximum absolute difference between an explicitly coded depth value and an interpolated depth value minus one into the bitstream; encoding a fourth flag indicating whether a decoded geometry and attribute data requires an additional spatial de-interleaving process during reconstruction into the bitstream; and encoding a fifth flag indicating whether a point local reconstruction mode information is present in the bitstream for the current atlas into the bitstream, where the third syntax element is not encoded in response to the fourth flag and the fifth flag being disabled.

According to one embodiment, the method further comprises encoding a sixth flag indicating whether there is extension data associated with at least one specific format of volumetric content into the bitstream, where the second flag is enabled in response to the sixth flag being enabled.

According to one embodiment, the method further comprises encoding a seventh flag indicating whether there are multi-view video extension syntax elements for a video-based point cloud compression (V-PCC) profile as being disabled into the bitstream.

According to one embodiment, the method further comprises encoding an eighth flag specifying whether a seventh flag is present as being disabled into the bitstream, where the seventh flag indicates whether there are multi-view video extension syntax elements for a V-PCC profile.

In a fourth aspect, an embodiment of the present disclosure provides an encoder. The encoder comprises a communication interface, a storage device, and a processor. The communication interface is configured to retrieve data of a volumetric video. The storage device is configured to store the data of the volumetric video. The processor is coupled to the communication interface and the storage device, and configured to process data of a volumetric video to determine whether a plurality of duplicated points are reconstructed for a current atlas, where each of the plurality of duplicated points is a point with same geometry coordinates as another point from an associated lower indexed map with a same patch, encode a first flag indicating whether the plurality of duplicated points are reconstructed for the current atlas into a bitstream of the volumetric video according to a result of the processing, and encode a second flag indicating whether there are point cloud extension syntax elements into the bitstream, where the first flag is not encoded in response to the second flag being disabled.

According to one embodiment, the processor is further configured to encode a third syntax element specifying a maximum absolute difference between an explicitly coded depth value and an interpolated depth value minus one into the bitstream, encode a fourth flag indicating whether a decoded geometry and attribute data requires an additional spatial de-interleaving process during reconstruction into the bitstream, and encode a fifth flag indicating whether a point local reconstruction mode information is present in the bitstream for the current atlas into the bitstream, where the third syntax element is not encoded in response to the fourth flag and the fifth flag being disabled.

According to one embodiment, the processor is further configured to encode a sixth flag indicating whether there is extension data associated with at least one specific format of volumetric content into the bitstream, where the second flag is enabled in response to the sixth flag being enabled.

According to one embodiment, the processor is further configured to encode a seventh flag indicating whether there are multi-view video extension syntax elements for a video-based point cloud compression (V-PCC) profile as being disabled into the bitstream.

According to one embodiment, the processor is further configured to encode an eighth flag specifying whether a seventh flag is present as being disabled into the bitstream, where the seventh flag indicates whether there are multi-view video extension syntax elements for a V-PCC profile.

In a fifth aspect, an embodiment of the present disclosure provides non-transitory computer readable recording medium storing a program that causes a computer to execute decoding, from a bitstream of a volumetric video, a first flag indicating whether a plurality of duplicated points are reconstructed for a current atlas, where each of the plurality of duplicated points is a point with same geometry coordinates as another point from an associated lower indexed map with a same patch; and setting a first default value to the first flag to indicate that the plurality of duplicated points are not reconstructed in response to the first flag being not present.

In a sixth aspect, an embodiment of the present disclosure provides non-transitory computer readable recording medium storing a program that causes a computer to execute processing data of a volumetric video to determine whether a plurality of duplicated points are reconstructed for a current atlas, where each of the plurality of duplicated points is a point with same geometry coordinates as another point from an associated lower indexed map with a same patch; encoding a first flag indicating whether the plurality of duplicated points are reconstructed for the current atlas into a bitstream of the volumetric video according to a result of the processing; and encoding a second flag indicating whether there are point cloud extension syntax elements into the bitstream, where the first flag is not encoded in response to the second flag being disabled.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic block diagram of a video encoding and decoding system related to an embodiment of the present disclosure.

FIG. 2A is a schematic block diagram of a video encoder related to an embodiment of the present disclosure.

FIG. 2B is a schematic block diagram of a video decoder related to an embodiment of the present disclosure.

FIG. 3 is a schematic diagram of the hardware structure of an encoder provided by an embodiment of the disclosure.

FIG. 4 is a flowchart of a visual volumetric video-based coding (V3C) method applied to an encoder according to an embodiment of the disclosure.

FIG. 5 is a schematic diagram of the hardware structure of a decoder provided by an embodiment of the disclosure.

FIG. 6 is a flowchart of a V3C method applied to a decoder according to an embodiment of the disclosure.

FIG. 7A and FIG. 7B are syntax tables in a visual volumetric video-based coding (V3C) according to an embodiment of the disclosure.

FIG. 8A to FIG. 8C are syntax tables in a visual volumetric video-based coding (V3C) according to an embodiment of the disclosure.

### DETAILED DESCRIPTION

In order to have a more detailed understanding of the characteristics and technical content of the embodiments of the present disclosure, the implementation of the embodiments of the present disclosure will be described in detail below with reference to the accompanying drawings. The attached drawings are for reference and explanation purposes only, and are not used to limit the embodiments of the present disclosure.

This disclosure proposes several improvements for Video-based Point Cloud Compression (V-PCC) in Visual Volumetric Video-based Coding (V3C) systems. The proposed method may be used in future V-PCC and V3C standards. With the implementation of the proposed method, modifications to bitstream structure, syntax, constraints, and mapping for generation of coded point cloud and multi-view video are considered for standardizing.

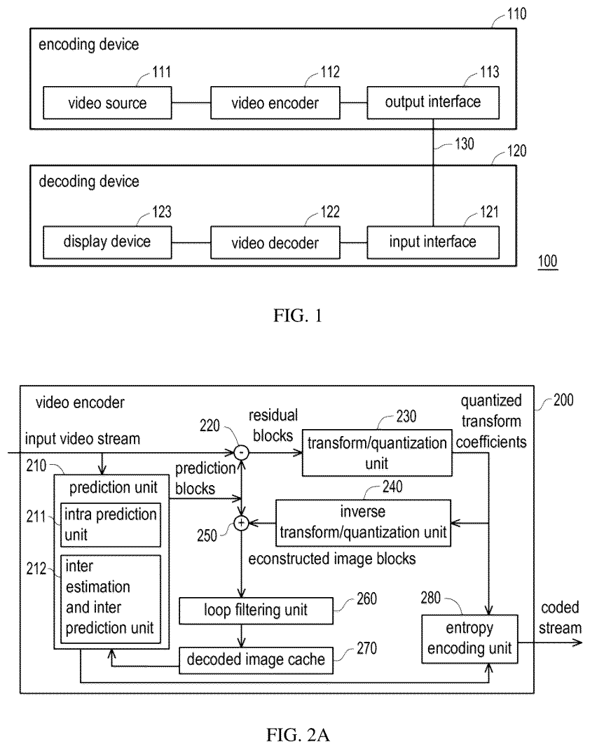

The coding involved in the embodiment of the present disclosure mainly includes video encoding and video decoding. To facilitate understanding, a video encoding and decoding system involved in the embodiment of the present disclosure is first introduced with reference to FIG. 1.

FIG. 1 is a schematic block diagram of a video encoding and decoding system related to an embodiment of the present disclosure. Referring to FIG. 1, the video encoding and decoding system 100 includes an encoding device 110 and a decoding device 120. The encoding device 110 is used to encode the video data (which can be understood as compression) to generate a code stream, and transmit the code stream to the decoding device 120. The decoding device 120 is used to decode the code stream generated by the encoding device 110 to generate decoded video data.

The encoding device 110 in the embodiment of the present disclosure can be understood as a device with a video encoding function, and the decoding device 120 can be understood as a device with a video decoding function. That is, the embodiment of the present disclosure includes a wider range of devices for the encoding device 110 and the decoding device 120, including but not limited to, for example, smartphones, desktop computers, mobile computing devices, notebook computers (e.g. laptops), tablet computers, set-top boxes, televisions, cameras, display devices, digital media players, video game consoles, vehicle-mounted computers, and the like.

In some embodiments, the encoding device 110 may transmit the encoded video data (e.g. code stream) to the decoding device 120 via a channel 130. The channel 130 may include one or more media and/or devices capable of transmitting the encoded video data from the encoding device 110 to the decoding device 120.

In one embodiment, the channel 130 includes one or more communication media that enables encoding device 110 to transmit the encoded video data directly to the decoding device 120 in real time. In this embodiment, the encoding device 110 may modulate the encoded video data according to the communication standard and transmit the modulated video data to the decoding device 120. The communication media includes wireless communication media, such as radio frequency spectrum. Optionally, the communication media may also include wired communication media, such as one or more physical transmission cables.

In another example, the channel 130 includes a storage medium that can store video data encoded by encoding device 110. The storage medium includes a variety of local access data storage medium, such as optical disk, DVD, flash memory, etc. In this example, the decoding device 120 may obtain the encoded video data from the storage medium.

In another embodiment, the channel 130 may include a storage server that may store video data encoded by the encoding device 110. In this embodiment, the decoding device 120 may download the stored encoded video data from the storage server. Optionally, the storage server may store the encoded video data and may transmit the encoded video data to the decoding device 120, such as a web server, a File Transfer Protocol (FTP) server, etc.

In some embodiments, the encoding device 110 includes a video encoder 112 and an output interface 113. In some embodiments, the output interface 113 may include a modulator/demodulator (modem) and/or a transmitter.

In some embodiments, the encoding device 110 may include a video source 111 in addition to the video encoder 112 and the output interface 113.

The video source 111 may include at least one of a video capturing device (e.g. a video camera), a video archive, a video input interface for receiving video data from a video content provider, a computer graphics system used to generate video data.

The video encoder 112 encodes the video data from the video source 111 to generate a code stream. The video data may include one or more images (pictures) or sequence of pictures (sequence of pictures). The code stream contains encoding information of an image or an image sequence in a form of bitstream. The encoding information may include encoded image data and associated data. The associated data may include sequence parameter set (SPS), picture parameter set (PPS) and other syntax structures. An SPS can contain parameters that apply to one or more sequences. A PPS can contain parameters that apply to one or more images. A syntax structure refers to a collection of zero or more syntax elements arranged in a specified order in a code stream.

The video encoder 112 transmits the encoded video data directly to the decoding device 120 via the output interface 113. The encoded video data can also be stored on a storage medium or a storage server for subsequent reading by the decoding device 120.

In some embodiments, the decoding device 120 includes an input interface 121 and a video decoder 122.

In some embodiments, in addition to the input interface 121 and the video decoder 122, the decoding device 120 may also include a display device 123.

The input interface 121 includes a receiver and/or a modem. The input interface 121 may receive the encoded video data over the channel 130.

The video decoder 122 is used to decode the encoded video data to obtain decoded video data, and transmit the decoded video data to the display device 123.

The display device 123 displays the decoded video data. In some embodiments, the display device 123 may be integrated with the decoding device 120 or may be external to the decoding device 120. The display device 123 may include a variety of display devices, such as a liquid crystal display (LCD), a plasma display, an organic light emitting diode (OLED) display, or other types of display devices.

It is noted, FIG. 1 is only an example, and the technical solution of the embodiment of the present disclosure is not limited to FIG. 1. For example, the technology of the present disclosure can also be applied to unilateral video encoding or unilateral video decoding.

The video coding framework involved in the embodiments of this disclosure is introduced below.

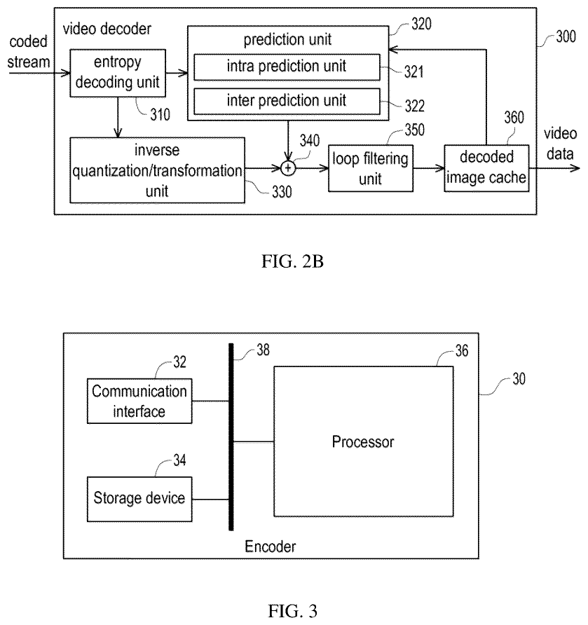

FIG. 2A is a schematic block diagram of a video encoder related to an embodiment of the present disclosure. It should be understood that the video encoder 200 can be used to perform lossy compression on images, or used to perform lossless compression on images. The lossless compression can be visually lossless compression or mathematically lossless compression, and the embodiment is not limited thereto.

The video encoder 200 can be applied to image data in a luminance-chrominance (YCbCr, YUV) format. For example, the YUV ratio can be 4:2:0, 4:2:2 or 4:4:4, in which Y represents brightness (Luma), Cb (U) represents blue chroma, Cr (V) represents red chroma, and U and V represent Chroma which is used to describe color and saturation. For example, in the color format, 4:2:0 means that every 4 pixels have 4 luminance components and 2 chrominance components (YYYYCbCr), 4:2:2 means that every 4 pixels have 4 luminance components and 4 Chroma component (YYYYCbCrCbCr), 4:4:4 means full pixel display (YYYYCbCrCbCrCbCrCbCr).

For example, the video encoder 200 reads video data, and for each frame of images in the video data, divides one frame of image into several coding tree units (CTUs). In some examples, the CTU may be called “Tree block”, “Largest Coding unit (LCU)” or “coding tree block (CTB)”. Each CTU can be associated with an equal-sized block of pixels within the image. Each pixel can correspond to one luminance (or luma) sample and two chrominance (or chroma) samples. Therefore, each CTU can be associated with one block of luma samples and two blocks of chroma samples. A size of the CTU is, for example, 128×128, 64×64, 32×32, etc. A CTU can be further divided into several coding units (CUs) for encoding. The CUs can be rectangular blocks or square blocks. A CU can be further divided into prediction units (PUs) and transform units (TUs), thus enabling coding, prediction, and transformation to be separated, and enabling processing to be more flexible. In an example, the CTU is divided into CUs in a quad-tree manner, and the CU is divided into TUs and PUs in a quad-tree manner.

The video encoders and the video decoders can support various PU sizes. Assuming that the size of a specific CU is 2N×2N, the video encoder and the video decoder can support a PU size of 2N×2N or N×N for intra-frame prediction, and support 2N×2N, 2N×N, N×2N, N×N or similar sized symmetric PU for inter-frame prediction. The video encoder and the video decoder can also support 2N×nU, 2N×nD, nL×2N and nR×2N asymmetric PUs for inter-frame prediction.

In some embodiments, as shown in FIG. 2A, the video encoder 200 may include a prediction unit 210, a residual unit 220, a transform/quantization unit 230, an inverse transform/quantization unit 240, a reconstruction unit 250, and a loop filtering unit 260, a decoded image cache 270, and an entropy encoding unit 280. It should be noted that the video encoder 200 may include more, less, or different functional components.

Optionally, in this disclosure, the current block may be called the current coding unit (CU) or the current prediction unit (PU), etc. The prediction block may also be called a predicted image block or an image prediction block, and the reconstructed image block may also be called a reconstruction block or an image reconstructed image block.

In some embodiments, the prediction unit 210 includes an intra prediction unit 211 and an inter estimation and inter prediction unit 212. Since there is a strong correlation between adjacent pixels in a video frame, the intra-frame prediction method is used in video encoding and decoding technology to eliminate the spatial redundancy between adjacent pixels. Since there is a strong similarity between adjacent frames in the video, an inter-frame prediction method is used in video coding and decoding technology to eliminate the temporal redundancy between adjacent frames, thereby improving coding efficiency.

The inter estimation and inter prediction unit 212 can be used for inter-frame prediction. The inter-frame prediction can include motion estimation and motion compensation, which may refer to image information of different frames. The inter-frame prediction uses motion information to find reference blocks from reference frames and generates prediction blocks based on the reference blocks to eliminate temporal redundancy. The frames used in inter-frame prediction can be P frames and/or B frames, in which the P frames refer to forward prediction frames, and the B frames refer to bidirectional predictions frame. The inter-frame prediction uses motion information to find reference blocks from reference frames and generate prediction blocks based on the reference blocks. The motion information includes a reference frame list where the reference frame is located, a reference frame index, and motion vectors. The motion vectors can be in whole pixels or sub-pixels. If the motion vectors are in sub-pixels, then interpolation filtering needs to be used in the reference frame to make the required sub-pixel blocks. Here, a block of whole pixels or sub-pixels in the reference frame found according to the motion vectors is called a reference block. Some technologies will directly use the reference block as a prediction block, and some technologies will reprocess to generate a prediction block based on the reference block. Reprocessing to generate the prediction block based on the reference block can also be understood as using the reference block as a prediction block and then processing to generate a new prediction block based on the prediction block.

The intra prediction unit 211 only refers to the information of the same frame image and predicts the pixel information in the current coded image block to eliminate spatial redundancy. The frames used in intra-frame prediction may be I frames.

The intra-frame prediction has multiple prediction modes. Taking the international digital video coding standard H series as an example, the H.264/AVC standard has 8 angle prediction modes and 1 non-angle prediction mode, and H.265/HEVC has been extended to 33 angle prediction modes and 2 non-angle prediction modes. The intra-frame prediction modes used by HEVC include a planar mode, a DC mode and 33 angle modes, for a total of 35 prediction modes. The intra-frame modes used by VVC include a planar mode, a DC mode and 65 angle modes, for a total of 67 prediction modes.

It should be noted that with the increase of angle modes, the intra-frame prediction will be more accurate and more in line with the development needs of high-definition and ultra-high-definition digital videos.

The residual unit 220 may generate a residual block of the CU based on the pixel block of the CU and the prediction block of the PU of the CU. For example, the residual unit 220 may generate a residual block of a CU such that each sample in the residual block has a value equal to the difference between a sample in the pixel block of the CU and a corresponding sample in the prediction block of the PU of the CU.

The transform/quantization unit 230 may quantize the transform coefficients. The transform/quantization unit 230 may quantize the transform coefficients associated with the TU of the CU based on quantization parameter (QP) values associated with the CU. The Video encoder 200 may adjust the degree of quantization applied to the transform coefficients associated with the CU by adjusting the QP value associated with the CU.

The inverse transform/quantization unit 240 may apply inverse quantization and inverse transform to the quantized transform coefficients, respectively, to reconstruct the residual block from the quantized transform coefficients.

The reconstruction unit 250 may add samples of the reconstructed residual block to corresponding samples of one or more prediction blocks generated by the prediction unit 210 to produce a reconstructed image block associated with the TU. By reconstructing blocks of samples for each TU of a CU in this manner, the video encoder 200 can reconstruct blocks of pixels of the CU.

The loop filtering unit 260 is used to process the inversely transformed and inversely quantized pixels to compensate for distortion information and provide a better reference for subsequent encoding of pixels. For example, a deblocking filtering operation can be performed to reduce the block effect of the pixel blocks associated with the CU.

In some embodiments, the loop filtering unit 260 includes a deblocking filtering unit and a sample adaptive compensation/adaptive loop filtering (SAO/ALF) unit, where the deblocking filtering unit is used to remove blocking effects, and the SAO/ALF unit is used to remove ringing effects.

The decoded image cache 270 may store reconstructed pixel blocks. The inter estimation and inter prediction unit 212 may perform inter-frame prediction on PUs of other images using reference images containing the reconstructed pixel blocks. Additionally, the intra prediction unit 211 may use the reconstructed pixel blocks in the decoded image cache 270 to perform intra-frame prediction on other PUs in the same image as the CU.

The entropy encoding unit 280 may receive the quantized transform coefficients from the transform/quantization unit 230. The entropy encoding unit 280 may perform one or more entropy encoding operations on the quantized transform coefficients to generate entropy encoded data.

FIG. 2B is a schematic block diagram of a video decoder related to an embodiment of the present disclosure.

As shown in FIG. 2B, the video decoder 300 includes an entropy decoding unit 310, a prediction unit 320, an inverse quantization/transformation unit 330, a reconstruction unit 340, a loop filtering unit 350 and a decoded image cache 360. It should be noted that the video decoder 300 may include more, less, or different functional components.

The video decoder 300 can receive the coded stream. The entropy decoding unit 310 may parse the coded stream to extract syntax elements from the coded stream. As part of parsing the coded stream, the entropy decoding unit 310 may parse entropy-encoded syntax elements in the coded stream. The prediction unit 320, the inverse quantization/transformation unit 330, the reconstruction unit 340 and the loop filtering unit 350 may decode the video data according to the syntax elements extracted from the code stream, and generate decoded video data.

In some embodiments, prediction unit 320 includes intra prediction unit 321 and inter prediction unit 322.

The intra prediction unit 321 may perform intra prediction to generate predicted blocks for the PU. The intra prediction unit 321 may use an intra prediction mode to generate predicted blocks for a PU based on pixel blocks of spatially neighboring PUs. The intra prediction unit 321 may also determine the intra prediction mode of the PU based on one or more syntax elements parsed from the coded stream.

The inter prediction unit 322 may construct a first reference image list (List 0) and a second reference image list (List 1) according to syntax elements parsed from the coded stream. Additionally, if the PU uses inter-prediction encoding, the entropy decoding unit 310 may parse the motion information of the PU. The inter prediction unit 322 may determine one or more reference blocks for the PU based on the motion information of the PU. The inter prediction unit 322 may generate a predictive block for the PU based on one or more reference blocks of the PU.

The inverse quantization/transform unit 330 may inversely quantize (i.e. dequantize) the transform coefficients associated with a TU. The inverse quantization/transform unit 330 may use the QP value associated with the CU of the TU to determine a degree of quantization.

After inversely quantizing the transform coefficients, the inverse quantization/transform unit 330 may apply one or more inverse transforms to the inverse-quantized transform coefficients to produce a residual block associated with the TU.

The reconstruction unit 340 uses the residual blocks associated with the TU of the CU and the prediction blocks of the PU of the CU to reconstruct the pixel blocks of the CU. For example, the reconstruction unit 340 may add samples of the residual block to corresponding samples of the prediction block to reconstruct the pixel block of the CU and obtain a reconstructed image block.

The loop filtering unit 350 may perform deblocking filtering operations to reduce blocking artifacts for blocks of pixels associated with the CU.

The video decoder 300 may store the reconstructed image of the CU in the decoded image cache 360. The video decoder 300 may use the reconstructed image in the decoded image cache 360 as a reference image for subsequent prediction, or transmit the reconstructed image to a display device for presentation.

The basic process of video encoding and video decoding is as follows.

At the encoding end, an image frame is divided into blocks. For a current block, the prediction unit 210 uses intra prediction or inter prediction to generate a prediction block of the current block. The residual unit 220 may calculate a residual block based on the prediction block and an original block of the current block, that is, the difference between the prediction block and the original block of the current block. The residual block may also be called residual information. The residual block undergoes processes such as transformation and quantization performed by the transformation/quantization unit 230 can remove information that is insensitive to human eyes and eliminate visual redundancy. Optionally, the residual block before the transformation and quantization by the transformation/quantization unit 230 may be called a time domain residual block, and the time domain residual block after the transformation and quantization by the transformation/quantization unit 230 may be called a frequency residual block or a frequency domain residual block. The entropy encoding unit 280 receives the quantized change coefficients output from the transform quantization unit 230, and may perform entropy encoding on the quantized change coefficients to output a code stream. For example, the entropy encoding unit 280 may eliminate character redundancy according to a target context model and probability information of the binary code stream.

At the decoding end, the entropy decoding unit 310 can parse the coded stream to obtain the prediction information, quantization coefficient matrix, and the like of the current block. The prediction unit 320 uses the intra prediction or the inter prediction for the current block based on the prediction information to generate a prediction block of the current block. The inverse quantization/transform unit 330 uses the quantization coefficient matrix obtained from the coded stream to perform inverse quantization and inverse transformation on the quantization coefficient matrix to obtain a residual block. The reconstruction unit 340 adds the prediction block and the residual block to obtain a reconstruction block. The reconstructed blocks constitute a reconstructed image, and the loop filtering unit 350 performs loop filtering on the reconstructed image based on the image or based on the blocks to obtain a decoded image. The decoded image may also be called a reconstructed image, and the reconstructed image may be used as a reference frame for inter-frame prediction for subsequent frames.

It should be noted that the block division information determined by the encoding end, as well as mode information or parameter information such as prediction, transformation, quantization, entropy coding, loop filtering, etc., are carried in the coded stream when necessary. The decoding end determines the block division information, the prediction, transformation, quantization, entropy coding, loop filtering and other mode information or parameter information the same as the encoding end by parsing the code stream and analyzing the existing information, thereby ensuring the image encoded by the encoding end is the same as the decoded image obtained by the decoding end.

The above is the basic process of the video codec under the block-based hybrid coding framework. With the development of technology, some modules or steps of the framework or process may be optimized. The present disclosure is applicable to the basic process of the video codec under the block-based hybrid coding framework, but is not limited to this framework and process.

In some disclosure scenarios, multiple heterogeneous contents appear simultaneously in the same three-dimensional scene, such as multi-view videos and point clouds. For multi-view videos, MPEG (Moving Picture Experts Group) immersive video (MIV) technology is used for encoding and decoding, and for point clouds, Video-based Point Cloud Compression (V-PCC) technology is used for encoding and decoding. In some embodiments, multi-view videos and point clouds are encoded and decoded using the frame packing technology in Visual Volumetric Video-based Coding (V3C).

### [Encoder]

FIG. 3 is a schematic diagram of the hardware structure of an encoder provided by an embodiment of the disclosure. Referring to FIG. 3, an encoder 30 includes a communication interface 32, a storage device 34, and a processor 36.

The communication interface 32 is, for example, a network card that supports wired network connections such as Ethernet, a wireless network card that supports wireless communication standards such as Institute of Electrical and Electronics Engineers (IEEE) 802.11n/b/g/ac/ax/be, or any other network connecting device, but the embodiment is not limited thereto. The communication interface 32 is configured to retrieve data of a volumetric video.

The storage device 34 may be a volatile memory or a non-volatile memory, or may include both volatile and non-volatile memory. Among them, the non-volatile memory can be read-only memory (Read-Only Memory, ROM), programmable read-only memory (Programmable ROM, PROM), erasable programmable read-only memory (Erasable PROM, EPROM), and electrically available Erase programmable read-only memory (Electrically EPROM, EEPROM) or flash memory. The volatile memory may be random access memory (Random Access Memory, RAM), which is used as an external cache. The storage device 34 described in this disclosure is configured to store the data of the volumetric video retrieved by the communication interface 32. In some embodiments, the storage device 34 is a non-transitory computer readable recording medium configured to storing a program that causes the processor 36 to execute a visual volumetric video-based coding (V3C) method as illustrated below.

The processor 36 is coupled to the communication interface 32 and the storage device 34 through a bus system 38. It can be understood that the bus system 38 is used as a data bus to implement connection and communication between these components. In addition to the data bus, the bus system 38 may also be a power bus, a control bus, a status signal bus or a combination thereof, but the embodiment is not limited thereto.

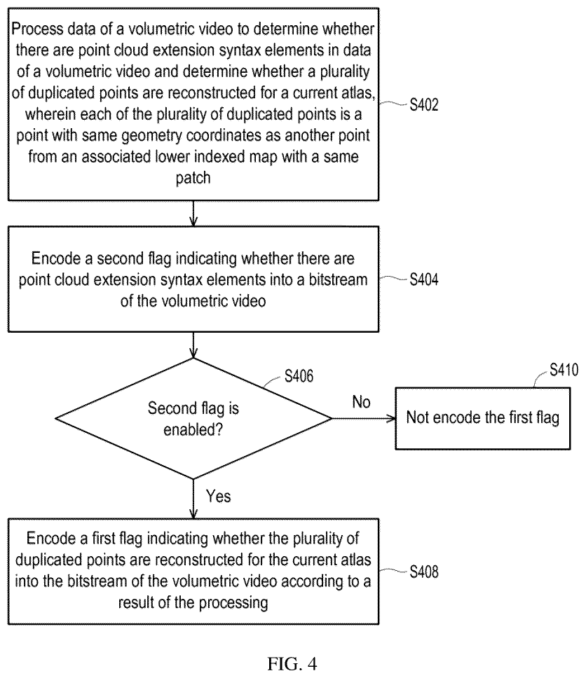

FIG. 4 is a flowchart of a visual volumetric video-based coding (V3C) method applied to an encoder according to an embodiment of the disclosure. With reference to FIG. 3 and FIG. 4 together, the method of this embodiment is applied to the encoder 30 in FIG. 3. Detailed steps of the V3C method of exemplary embodiments of the disclosure accompanied with the elements in the encoder 30 will now be described below.

In step S402, the processor 36 processes data of a volumetric video to determine whether a plurality of duplicated points shall be reconstructed for a current atlas, where each of the plurality of duplicated points is a point with same geometry coordinates as another point from an associated lower indexed map with a same patch.

In some embodiments, the volumetric video is comprised of a sequence of frames, and each frame contains volumetric content that is a 3D representation of a real-world object or scene captured from a moment in time. The volumetric content may be represented in a format of point cloud or multi-view video, but is not limited thereto. In some embodiments, the volumetric content may be represented in a format of V-mesh.

In detail, in 3D applications, such as virtual reality (VR), augmented reality (AR), or mixed reality (MR), visual volumetric content with different expression formats may appear in the same scene. Media objects, for example, may exist in the same 3D scene. In some embodiments, the background and some objects in the 3D scene are represented in a multi-view video, while some objects are represented in 3D point cloud.

In some embodiments, the volumetric content includes media contents simultaneously presented in the same 3D space. In some embodiments, the volumetric content includes media contents presented at different times in the same 3D space. In some embodiments, the volumetric content includes media contents in different 3D spaces. However, in the embodiments of this disclosure, there is no specific restriction on the volumetric content mentioned above.

In some embodiments, the formats for representing the volumetric content may be different. That is, the volumetric content may be represented in point clouds or multi-view videos, and various point cloud extension syntax elements and multi-view video extension syntax elements may be provided for coding the volumetric content.

In step S404, the processor 36 encodes a second flag indicating whether there are point cloud extension syntax elements into a bitstream of the volumetric video. The second flag is, for example, the syntax element “asps_vpcc_extension_present_flag” defined in the general atlas sequence parameter set (ASPS) raw byte sequence payload (RBSP) syntax table in V3C standard.

In step S406, the processor 36 determines whether the second flag is enabled, that is, whether a value of the second flag is equal to 1.

In step S408, the processor 36 encodes a first flag indicating whether the plurality of duplicated points shall be reconstructed for the current atlas into the bitstream of the volumetric video in response to the second flag being enabled. The first flag is, for example, the syntax element “asps_vpcc_remove_duplicate_point_enabled_flag” defined in the ASPS V-PCC syntax table in V3C standard.

In step S410, the processor 36 does not encode the first flag in response to the second flag being not enabled, that is, a value of the second flag being equal to 0.

In some embodiments, the processor 36 may further encodes a fourth flag indicating whether a decoded geometry and attribute data requires an additional spatial de-interleaving process during reconstruction into the bitstream, and encodes a fifth flag indicating whether a point local reconstruction mode information is present in the bitstream for the current atlas into the bitstream. The fourth flag is, for example, the syntax element “asps_pixel_deinterleaving_enabled_flag” while the fifth flag is, for example, the syntax element “asps_plr_enabled_flag” defined in the general ASPS RBSP syntax table in V3C standard.

Accordingly, the processor 36 may determine whether the fourth flag and the fifth flag are disabled, and encode a third syntax element specifying a maximum absolute difference between an explicitly coded depth value and an interpolated depth value minus one into the bitstream in response to the fourth flag or the fifth flag being enabled. On the other hand, the processor 36 may not encode the third syntax element in response to the fourth flag and the fifth flag being both disabled. The third syntax element is, for example, the syntax element “asps_vpcc_surface_thickness_minus1” defined in the ASPS V-PCC syntax table in V3C standard.

In some embodiments, the processor 36 may further encode a sixth flag indicating whether there is extension data associated with at least one specific format of volumetric content into the bitstream, and encode the second flag in response to the sixth flag being enabled. The sixth flag is, for example, the syntax element “asps_extension_present_flag” defined in the general ASPS RBSP syntax table in V3C standard. It is a requirement of bitstream conformance that when the value of the syntax element “asps_extension_present_flag” is equal to 1, the value of the syntax element “asps_vpcc_extension_present_flag” should be equal to 1 for a VPCC bitstream.

In some embodiments, the processor 36 may further encode a seventh flag indicating whether there are multi-view video extension syntax elements for a video-based point cloud compression (V-PCC) profile as being disabled into the bitstream. The seventh flag is, for example, an extension present flag “afps_miv_extension_present_flag” defined in the general atlas frame parameter set (AFPS) RBSP syntax table in V3C standard, and coded in the V-PCC toolset profile to indicate if there are multi-view video extension syntax elements presented. As the extension present flag “afps_miv_extension_present_flag” is set to be 0 for V-PCC toolset profile, there is no MIV related syntax elements parsed for the V-PCC bitstream.

In some embodiments, the processor 36 may further encode an eighth flag specifying whether the seventh flag is present as being disabled into the bitstream. The seventh flag indicates whether there are multi-view video extension syntax elements for a V-PCC profile. The eighth flag is, for example, an extension present flag “afps_extension_present_flag” defined in the general AFPS RBSP syntax table in V3C standard, and coded in the V-PCC toolset profile to indicate if the extension present flag “afps_miv_extension_present_flag” is presented. As the extension present flag “afps_extension_present_flag” is set to be 0 for V-PCC toolset profile, the extension present flag “afps_miv_extension_present_flag” is also set to be 0, and thus there is no MIV related syntax elements parsed for the V-PCC bitstream.

Based on the above, the encoder 30 of the present embodiment may encode volumetric content of a volumetric video represented in different formats into one bitstream with the syntax element “asps_vpcc_remove_duplicate_point_enabled_flag” being presented or not presented, so as to facilitate coding of V-PCC bitstream.

### [Decoder]

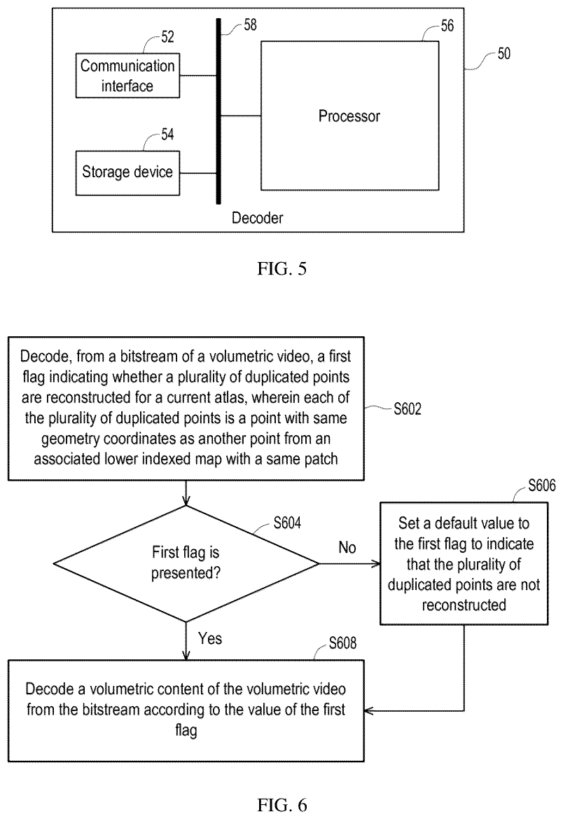

FIG. 5 is a schematic diagram of the hardware structure of a decoder provided by an embodiment of the disclosure. Referring to FIG. 5, a decoder 50 includes a communication interface 52, a storage device 54, and a processor 56 coupled to the communication interface 52 and the storage device 54 through a bus system 58.

It can be understood that the hardware structures of the communication interface 52, the storage device 54, the processor 56, and the bus system 58 are similar to those of the communication interface 32, the storage device 34, the processor 36, and the bus system 38, and therefore the details are not described herein again. In some embodiments, the storage device 54 is a non-transitory computer readable recording medium configured to storing a program that causes the processor 56 to execute a visual volumetric video-based coding (V3C) method as illustrated below.

In the present embodiment, the communication interface 52 is configured to retrieve a bitstream of a volumetric video, and the storage device 54 is configured to store the bitstream of the volumetric video.

FIG. 6 is a flowchart of a V3C method applied to a decoder according to an embodiment of the disclosure. With reference to FIG. 5 and FIG. 6 together, the method of this embodiment is applied to the decoder 50 in FIG. 5. Detailed steps of the V3C method of exemplary embodiments of the disclosure accompanied with the elements in the decoder 50 will now be described below.

In step S602, the processor 56 decodes, from a bitstream of a volumetric video, a first flag indicating whether a plurality of duplicated points are reconstructed for a current atlas, where each of the plurality of duplicated points is a point with same geometry coordinates as another point from an associated lower indexed map with a same patch. The first flag is, for example, the syntax element “asps_vpcc_remove_duplicate_point_enabled_flag” defined in the general ASPS V-PCC syntax table in V3C standard.

In step S604, the processor 56 determines whether the first flag is present in decoding the bitstream.

In step S606, the processor 56 sets a first default value to the first flag to indicate that the plurality of duplicated points shall not be reconstructed in response to the first flag being not present. In some embodiments, the processor 56 sets a value of the first flag to be one to indicate that the plurality of duplicated points shall not be reconstructed for the current atlas.

In step S608, the processor 56 decodes a volumetric content of the volumetric video from the bitstream according to the value of the first flag. In details, the value of the first flag being equal to one indicates that duplicated points shall not be reconstructed for the current atlas, where a duplicated point is a point with the same 2D and 3D geometry coordinates as another point from a lower indexed map associated with the same patch. The value of the first flag being equal to zero indicates that all points shall be reconstructed.

In some embodiments, the processor 56 further decodes, from the bitstream, a second syntax element specifying a maximum absolute difference between an explicitly coded depth value and an interpolated depth value minus one. The second syntax element is, for example, the syntax element “asps_vpcc_surface_thickness_minus1” defined in the general ASPS V-PCC syntax table in V3C standard. The maximum absolute difference between the explicitly coded depth value and the interpolated depth value is equal to the value of the second syntax element plus one. The processor 56 may determine whether the second syntax element is presented in decoding the bitstream, and set a second default value to the second syntax element in response to the second syntax element being not present. That is, the processor 56 may set a value of the second syntax element to be zero, so as to set the maximum absolute difference to be equal to one, and decode the volumetric content from the bitstream to reconstruct the volumetric video according to the values of the first flag and the second syntax element.

In some embodiments, the processor 56 decodes, from the bitstream, a third flag indicating whether there is extension data associated with at least one specific format of volumetric content in the bitstream, and decodes a fourth flag indicating whether there are point cloud extension syntax elements, in which the fourth flag is enabled in response to the third flag being enabled. Accordingly, the processor 56 decodes the point cloud extension syntax elements from the bitstream according to the value of the fourth flag, and decodes the volumetric content from the bitstream using the point cloud extension syntax elements to reconstruct the volumetric video. The third flag is, for example, the syntax element “asps_extension_present_flag” defined in the general ASPS RBSP syntax table in V3C standard, and the fourth flag is, for example, the syntax element “asps_vpcc_extension_present_flag” defined in the general ASPS RBSP syntax table in V3C standard. It is a requirement of bitstream conformance that when the value of the syntax element “asps_extension_present_flag” is equal to 1, the value of the syntax element “asps_vpcc_extension_present_flag” should be equal to 1 for a VPCC bitstream.

In some embodiments, the processor 56 decodes, from the bitstream, a fifth flag indicating whether there are multi-view video extension syntax elements for a video-based point cloud compression (V-PCC) profile, and decodes, from the bitstream, the point cloud extension syntax elements without the multi-view video extension syntax elements for the V-PCC profile in response to the fifth flag being disabled. The fifth flag is, for example, an extension present flag “afps_miv_extension_present_flag” defined in the general AFPS RBSP syntax table in V3C standard, and coded in the V-PCC toolset profile to indicate if there are multi-view video extension syntax elements presented. As the extension present flag “afps_miv_extension_present_flag” is set to be 0 for V-PCC toolset profile, there is no MIV related syntax elements parsed for the bitstream of the volumetric video. Thus, the processor 56 decodes the point cloud extension syntax elements only without the multi-view video extension syntax elements for the V-PCC profile.

In some embodiments, the processor 56 decodes, from the bitstream, a sixth flag specifying whether a fifth flag is present. The sixth flag is, for example, an extension present flag “afps_extension_present_flag” defined in the general AFPS RBSP syntax table in V3C standard, and coded in the V-PCC toolset profile to indicate if the extension present flag “afps_miv_extension_present_flag” is presented. As the extension present flag “afps_extension_present_flag” is set to be 0 for V-PCC toolset profile, the extension present flag “afps_miv_extension_present_flag” is also set to be 0, and thus there is no MIV related syntax elements parsed for the bitstream of the volumetric video. Thus, the processor 56 decodes the point cloud extension syntax elements only without the multi-view video extension syntax elements for the V-PCC profile.

Based on the above, the decoder 50 of the present embodiment may decode volumetric content from the bitstream of the volumetric video even if the syntax elements “asps_vpcc_remove_duplicate_point_enabled_flag” and “asps_vpcc_surface_thickness_minus1” are not presented in the bitstream, so as to facilitate coding of V-PCC bitstream.

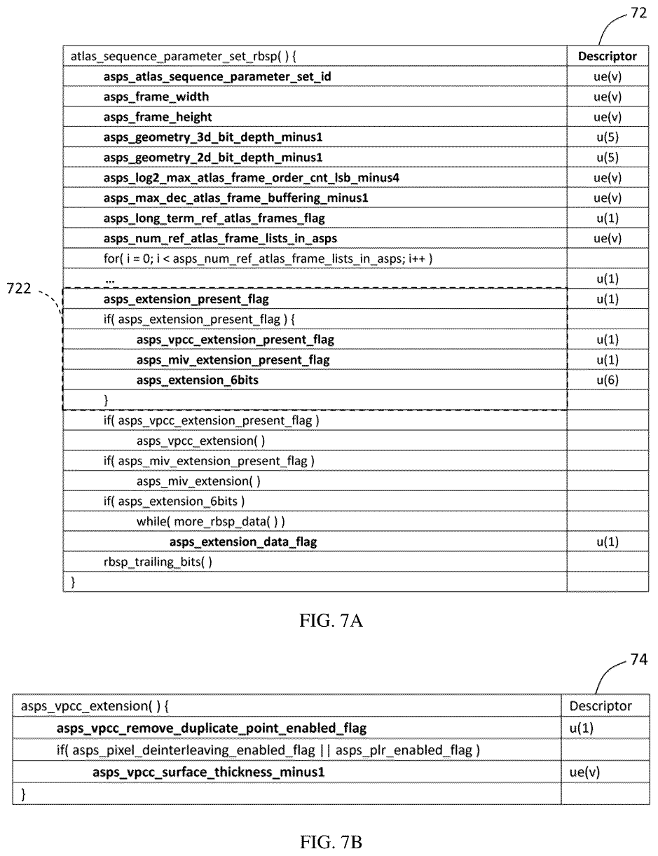

FIG. 7A and FIG. 7B are syntax tables in a visual volumetric video-based coding (V3C) according to an embodiment of the disclosure.

Referring to FIG. 7A, the syntax table 72 is a general ASPS RBSP syntax table, in which, in section 722, an extension present flag asps_extension_present_flag is coded to indicate whether the bitstream contains extended data for volumetric content. If the extension present flag asps_extension_present_flag is enabled, that is, equal to 1, an extension present flag asps_vpcc_extension_present_flag is coded to indicate if there are point cloud extension syntax elements presented while an extension present flag asps_miv_extension_present_flag is coded to indicate if there are multi-view video extension syntax elements presented.

Referring to FIG. 7B, the syntax table 74 is an ASPS V-PCC extension syntax table, in which a syntax element asps_vpcc_remove_duplicate_point_enabled_flag is coded to indicate whether duplicated points shall not be reconstructed for the current atlas, where a duplicated point is a point with the same 2D and 3D geometry coordinates as another point from a lower indexed map associated with the same patch. In details, the value of the syntax element asps_vpcc_remove_duplicate_point_enabled_flag being equal to one indicates duplicated points shall not be reconstructed for the current atlas, and the value of the syntax element asps_vpcc_remove_duplicate_point_enabled_flag being equal to zero indicates that all points shall be reconstructed. In the present embodiment, when the syntax element asps_vpcc_remove_duplicate_point_enabled_flag is not presented in the bitstream, the decoder sets the value of the syntax element asps_vpcc_remove_duplicate_point_enabled_flag to be one, so as to facilitate coding of V-PCC bitstream.

In addition, as shown in the syntax table 74, when the syntax element asps_pixel_deinterleaving_enabled_flag or asps_plr_enabled_flag is enabled (i.e. equal to one), the syntax element asps_vpcc_surface_thickness_minus1 is coded, and a maximum absolute difference between an explicitly coded depth value and an interpolated depth value is calculated as the value of the syntax element asps_vpcc_surface_thickness_minus1 plus one. In the present embodiment, when the syntax element asps_vpcc_surface_thickness_minus1 is not presented in the bitstream, the decoder sets the value of the syntax element asps_vpcc_surface_thickness_minus1 to be zero, so as to facilitate coding of V-PCC bitstream.

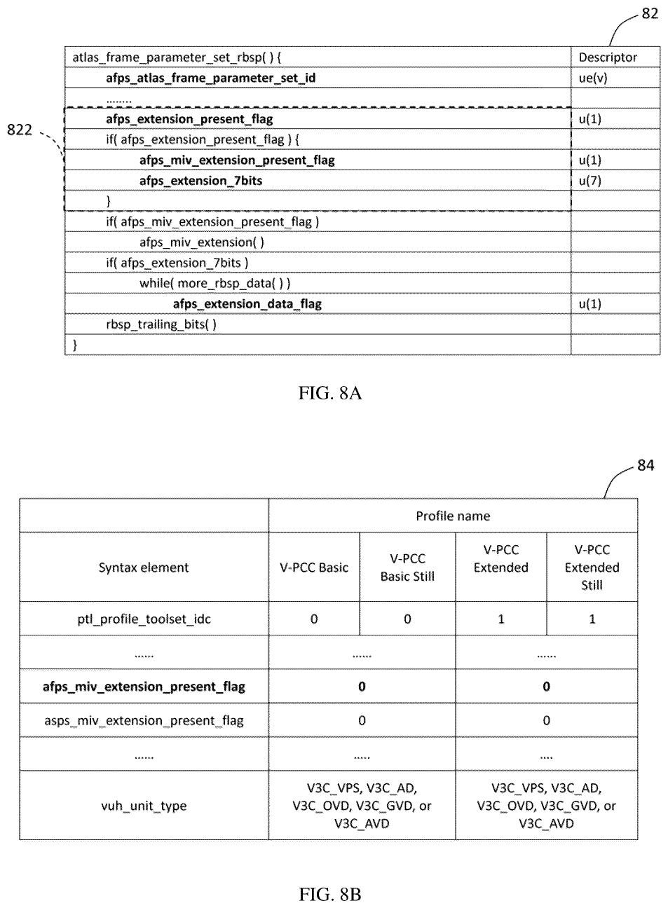

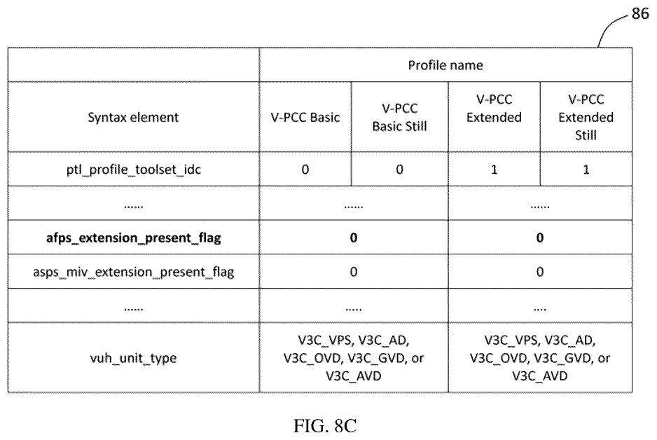

FIG. 8A to FIG. 8C are syntax tables in a visual volumetric video-based coding (V3C) according to an embodiment of the disclosure.

Referring to FIG. 8A, the syntax table 82 is a general AFPS RBSP syntax table, in which, in section 822, an extension present flag afps_extension_present_flag is coded to indicate whether there is extension data associated with at least one specific format of volumetric content in the bitstream. If the extension present flag afps_extension_present_flag is enabled, that is, equal to 1, an extension present flag afps_miv_extension_present_flag is coded to indicate if there are multi-view extension video syntax elements coded into bitstream.

Referring to FIG. 8B, the syntax table 84 is a table of syntax element values for the V-PCC toolset profile components that includes maximum allowed syntax element values for the V-PCC toolset profile components, in which the value of the extension present flag afps_miv_extension_present_flag is set to be disabled, that is, equal to 0. That is, for a V-PCC profile, the extension present flags afps_miv_extension_present_flag is set to zero, and thus there is no MIV related syntax elements parsed for the V-PCC bitstream, so as to facilitate coding of V-PCC bitstream.

Referring to FIG. 8C, the syntax table 86 is also a table of syntax element values for the V-PCC toolset profile components that, in which the value of the extension present flag afps_extension_present_flag is set to be disabled, that is, equal to 0, which indicates the extension present flag afps_miv_extension_present_flag is disabled (equal to 0), and thus there is no MIV related syntax elements parsed for the V-PCC bitstream, so as to facilitate coding of V-PCC bitstream.

To sum up, in the visual volumetric video-based coding (V3C) method, the encoder, and the decoder of the disclosure, default values are defined for some V-PCC related syntax elements, and a fix is proposed to the table of syntax element values for the V-PCC toolset profile components. Accordingly, the atlas extension related syntax elements can be parsed to help decode a V-PCC bitstream. More specifically, when the extension present flag is equal to one, several atlas extension related syntax elements, including V-PCC extension present flag, will be parsed, and when the V-PCC extension present flag is equal to one, the V-PCC extension related syntax elements will be further parsed, so as to facilitate coding of V-PCC bitstream.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A visual volumetric video-based coding (V3C) method, applied to a decoder, comprising:
decoding, from a bitstream of a volumetric video, a first flag indicating whether a plurality of duplicated points are reconstructed for a current atlas, wherein each of the plurality of duplicated points is a point with same geometry coordinates as another point from an associated lower indexed map with a same patch;
setting a first default value to the first flag to indicate that the plurality of duplicated points are not reconstructed in response to the first flag being not present; and
decoding a volumetric content from the bitstream to reconstruct the volumetric video according to a value of the first flag.

2. The method according to claim 1, further comprising:
decoding, from the bitstream, a second syntax element specifying a maximum absolute difference between an explicitly coded depth value and an interpolated depth value minus one;
setting a second default value to the second syntax element to set the maximum absolute difference to be equal to the second default value plus one in response to the second syntax element being not present; and
decoding the volumetric content from the bitstream to reconstruct the volumetric video according to the values of the first flag and the second syntax element.

3. The method according to claim 1, further comprising:
decoding, from the bitstream, a third flag indicating whether there is extension data associated with at least one specific format of volumetric content in the bitstream.

4. The method according to claim 3, further comprising:
decoding, from the bitstream, a fourth flag indicating whether there are point cloud extension syntax elements, wherein the fourth flag is enabled in response to the third flag being enabled;
decoding the point cloud extension syntax elements from the bitstream according to the value of the fourth flag; and
decoding the volumetric content from the bitstream using the point cloud extension syntax elements to reconstruct the volumetric video.

5. The method according to claim 4, further comprising:
decoding, from the bitstream, a fifth flag indicating whether there are multi-view video extension syntax elements for a video-based point cloud compression (V-PCC) profile; and
decoding, from the bitstream, the point cloud extension syntax elements without the multi-view video extension syntax elements for the V-PCC profile in response to the fifth flag being disabled.

6. The method according to claim 4, further comprising:
decoding, from the bitstream, a sixth flag specifying whether a fifth flag is present, wherein the fifth flag indicates whether there are multi-view video extension syntax elements for a V-PCC profile; and
decoding, from the bitstream, the point cloud extension syntax elements without the multi-view video extension syntax elements for the V-PCC profile in response to the sixth flag being disabled.

7. A decoder, comprising:
a communication interface, configured to retrieve a bitstream of a volumetric video;
a storage device, configured to store the bitstream of the volumetric video; and
a processor, coupled to the communication interface and the storage device, and configured to:
decode, from the bitstream of the volumetric video, a first flag indicating whether a plurality of duplicated points are reconstructed for a current atlas, wherein each of the plurality of duplicated points is a point with same geometry coordinates as another point from an associated lower indexed map with a same patch; and
set a first default value to the first flag to indicate that the plurality of duplicated points are not reconstructed in response to the first flag being not present; and
decode a volumetric content of the volumetric video from the bitstream to reconstruct the volumetric video according to a value of the first flag.

8. The decoder according to claim 7, wherein the processor is further configured to:
decode, from the bitstream, a second syntax element specifying a maximum absolute difference between an explicitly coded depth value and an interpolated depth value minus one;
set a second default value to the second syntax element to set the maximum absolute difference to be equal to the second default value plus one in response to the second syntax element being not present; and
decode the volumetric content from the bitstream to reconstruct the volumetric video according to the values of the first flag and the second syntax element.

9. The decoder according to claim 7, wherein the processor is further configured to:
decode, from the bitstream, a third flag indicating whether there is extension data associated with at least one specific format of volumetric content in the bitstream.

10. The decoder according to claim 9, wherein the processor is further configured to:
decode, from the bitstream, a fourth flag indicating whether there are point cloud extension syntax elements, wherein the fourth flag is enabled in response to the third flag being enabled;
decode the point cloud extension syntax elements from the bitstream according to the value of the fourth flag; and
decode the volumetric content from the bitstream using the point cloud extension syntax elements to reconstruct the volumetric video.

11. The decoder according to claim 10, wherein the processor is further configured to:
decode, from the bitstream, a fifth flag indicating whether there are multi-view video extension syntax elements for a video-based point cloud compression (V-PCC) profile; and
decode, from the bitstream, the point cloud extension syntax elements without the multi-view video extension syntax elements for the V-PCC profile in response to the fifth flag being disabled.

12. The decoder according to claim 10, wherein the processor is further configured to:
decode, from the bitstream, a sixth flag specifying whether a fifth flag is present, wherein the fifth flag indicates whether there are multi-view video extension syntax elements for a V-PCC profile; and
decode, from the bitstream, the point cloud extension syntax elements without the multi-view video extension syntax elements for the V-PCC profile in response to the sixth flag being disabled.

13. A visual volumetric video-based coding (V3C) method, applied to an encoder, comprising:
processing data of a volumetric video to determine whether there are point cloud extension syntax elements in data of the volumetric video and determine whether a plurality of duplicated points are reconstructed for a current atlas, wherein each of the plurality of duplicated points is a point with same geometry coordinates as another point from an associated lower indexed map with a same patch;
encoding a first flag indicating whether the plurality of duplicated points are reconstructed for the current atlas into a bitstream of the volumetric video according to a result of the processing; and
encoding a second flag indicating whether there are point cloud extension syntax elements into the bitstream, wherein
the first flag is not encoded in response to the second flag being disabled.

14. The method according to claim 13, further comprising:
encoding a third syntax element specifying a maximum absolute difference between an explicitly coded depth value and an interpolated depth value minus one into the bitstream;
encoding a fourth flag indicating whether a decoded geometry and attribute data requires an additional spatial de-interleaving process during reconstruction into the bitstream; and
encoding a fifth flag indicating whether a point local reconstruction mode information is present in the bitstream for the current atlas into the bitstream, wherein
the third syntax element is not encoded in response to the fourth flag and the fifth flag being disabled.

15. The method according to claim 13, further comprising:
encoding a sixth flag indicating whether there is extension data associated with at least one specific format of volumetric content into the bitstream, wherein
the second flag is enabled in response to the sixth flag being enabled.

16. The method according to claim 15, further comprising:
encoding a seventh flag indicating whether there are multi-view video extension syntax elements for a video-based point cloud compression (V-PCC) profile as being disabled into the bitstream.

17. The method according to claim 15, further comprising:
encoding an eighth flag specifying whether a seventh flag is present as being disabled into the bitstream, wherein the seventh flag indicates whether there are multi-view video extension syntax elements for a V-PCC profile.
